(19) United States
(12) Patent Application Publication
(10) Pub. No.: US 2011/0075880 A1
(43) Pub. Date: Mar. 31, 2011

(54) SPEAKER DAMPER AND SPEAKER INCLUDING THE SAME

(75) Inventors: Tomohiko Kamimura, Osaka (JP); Hideo Yuasa, Osaka (JP); Shuji Sato, Osaka (JP)

(73) Assignee: HOSIDEN CORPORATION, Osaka (JP)

(21) Appl. No.: 12/889,970

(22) Filed: Sep. 24, 2010

(30) Foreign Application Priority Data
Sep. 25, 2009 (JP) 2009-220170

(51) Int. Cl. H04R 1/00

(52) U.S. Cl. 381/413

(57) ABSTRACT

The invention provides a speaker damper (50) which can realize improvement of the productivity of a dynamic speaker (1), and a speaker (1) including the speaker damper. In the damper (50), lead portions (52) for guiding voice coil lead wires (21b) to external connection terminals (30) while laying the lead wires on one surface is disposed, and the process of laying the voice coil lead wires (21b) by means of forming is realized not in the air of the interior of a frame (60), but on one surfaces of the lead portions (52).

### TECHNICAL FIELD

The present invention relates to a speaker damper which is to be used in a small and thin dynamic speaker that can be employed in a portable telephone or the like, and also to a speaker including a speaker damper.

### BACKGROUND ART

A damper of a dynamic speaker cooperates with a diaphragm edge portion to play a role of holding a vibration system to a correct position to realize accurate vibration of the vibration system. Conductors for electrically connecting the voice coil to external connection terminals are disposed integrally with a damper (Patent Literature 1)

### PRIOR ART LITERATURE

### Patent Literature

[Patent Literature 1] Japanese Patent Application Laid-Open No. 9-307993

### SUMMARY OF THE INVENTION

### Problem to be Solved by the Invention

A damper having conductors can eliminate a process of laying lead wires of a voice coil by means of forming. The process constitutes a bottleneck of improvement of the productivity of a speaker. However, the voice coil and the damper conductors must be electrically connected to each other by using other lead wires, thereby causing the number of assembling steps and the component cost to be increased. Therefore, the configuration has an adverse effect on improvement of the productivity of a speaker.

It is an object of the invention to provide a speaker damper which can realize improvement of the productivity of a speaker, and a speaker including the speaker damper.

### Means for Solving the Problem

The speaker damper of the invention is used in a speaker including: a magnetic circuit having a yoke, a magnet, and a pole piece; a vibration system having a voice coil and diaphragm which are connected to each other through a voice coil bobbin; and a frame which holds the magnetic circuit, the vibration system, and external connection terminals, the voice coil being placed in a magnetic gap, and characterized in that voice coil lead wires are guided to the external connection terminals while being laid on one surface. The process of laying the voice coil lead wires by means of forming is realized not in the air of the interior of the frame, but on the one surface of the damper. Therefore, the process of laying the voice coil lead wires by means of forming can be performed easily and properly, the forming of the voice coil lead wires can be stabilized, and the positional accuracy of the voice coil lead wires with respect to the external connection terminals can be improved, so that improvement of the productivity of a speaker can be realized. The flex resistance of the voice coil lead wires can be improved, and also improvement of the input resistance characteristics of a speaker can be realized.

In the speaker damper of the invention, a damper body, and lead portions in which voice coil lead wires are guided to the external connection terminals while being laid on one surface are disposed, and the damper body includes: a movable portion which is coupled to an end portion of the voice coil bobbin opposite to the diaphragm; a fixed portion which is coupled to a stationary portion of the speaker; and a flexible portion through which the movable portion and the fixed portion are connected to each other, or the flexible portion includes a specific flexible portion which functions also as the lead portion. According to the configuration, the lower end of the vibration system which has a maximum distance from a diaphragm edge portion is supported by the damper body, and hence a high damper performance can be obtained. Moreover, two points, i.e., the upper and lower ends of the vibration system are supported by the diaphragm edge portion and the damper body, and hence the vibration system can produce more stable and accurate vibration. Therefore, the input resistance characteristics of a speaker can be further improved.

A speaker damper which has the above-described configuration may be formed by performing a punching process on one sheet-like member to have a planar structure. According to the configuration, a damper which can realize improvement of the productivity, thinning, and improvement of the input resistance characteristics of a speaker can be economically obtained.

The speaker of the invention is characterized in that it includes the the speaker damper of the invention.

### BRIEF DESCRIPTION OF THE DRAWINGS

FIGS. 1A to 1C are views illustrating a speaker damper of an embodiment (Embodiment 1) of the invention, FIG. 1A is a plan view of the speaker damper, FIG. 1B is a sectional view taken along line A-A′ in FIG. 1A, and FIG. 1C is a sectional view taken along line B-B′ in FIG. 1A.

FIG. 2 is a plan view of a speaker including the speaker damper shown in FIGS. 1A to 1C.

FIG. 3 is a sectional view taken along line A-A′ in FIG. 2.

FIG. 4 is a sectional view taken along line B-B′ in FIG. 2.

FIG. 5 is an exploded perspective view of the speaker of FIG. 2.

FIGS. 6A to 6C are views illustrating another speaker damper of another embodiment (Embodiment 2) of the invention, FIG. 6A is a plan view of the other speaker damper, FIG. 6B is a sectional view taken along line A-A′ in FIG. 6A, and FIG. 6C is a sectional view taken along line B-B′ in FIG. 6A.

FIG. 7 is a plan view of another speaker including the other speaker damper shown in FIGS. 6A to 6C.

FIG. 8 is a sectional view taken along line A-A′ in FIG. 7.

FIG. 9 is a sectional view taken along line B-B′ in FIG. 7.

### MODE FOR CARRYING OUT THE INVENTION

### Embodiment 1

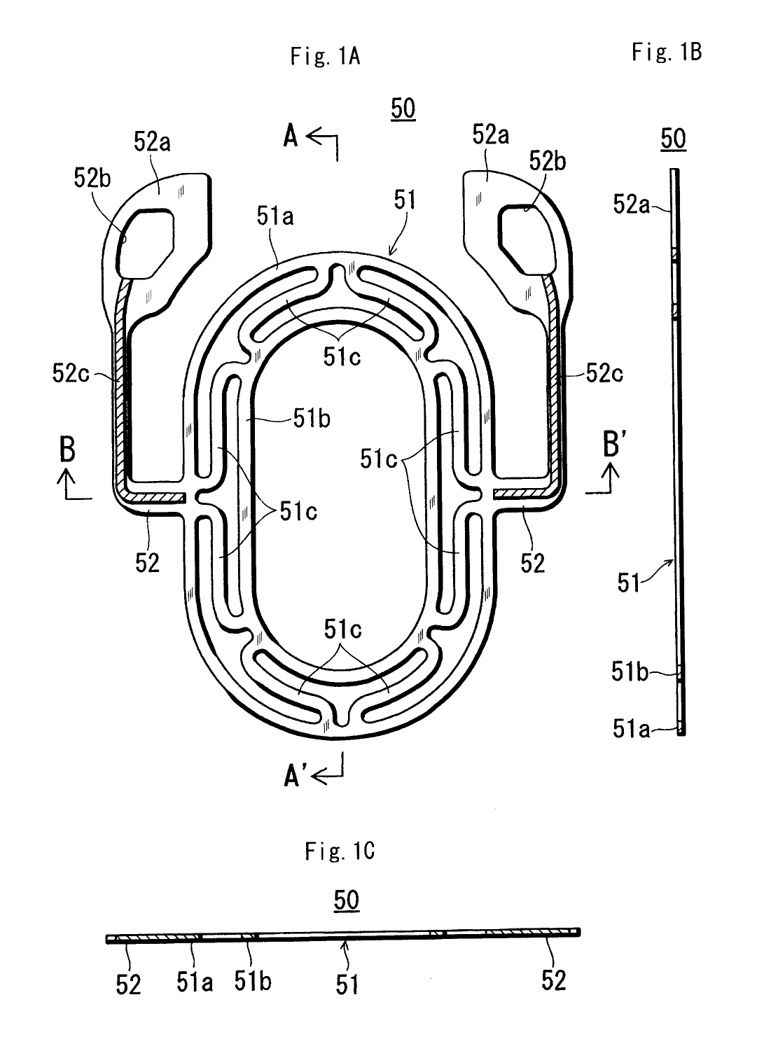

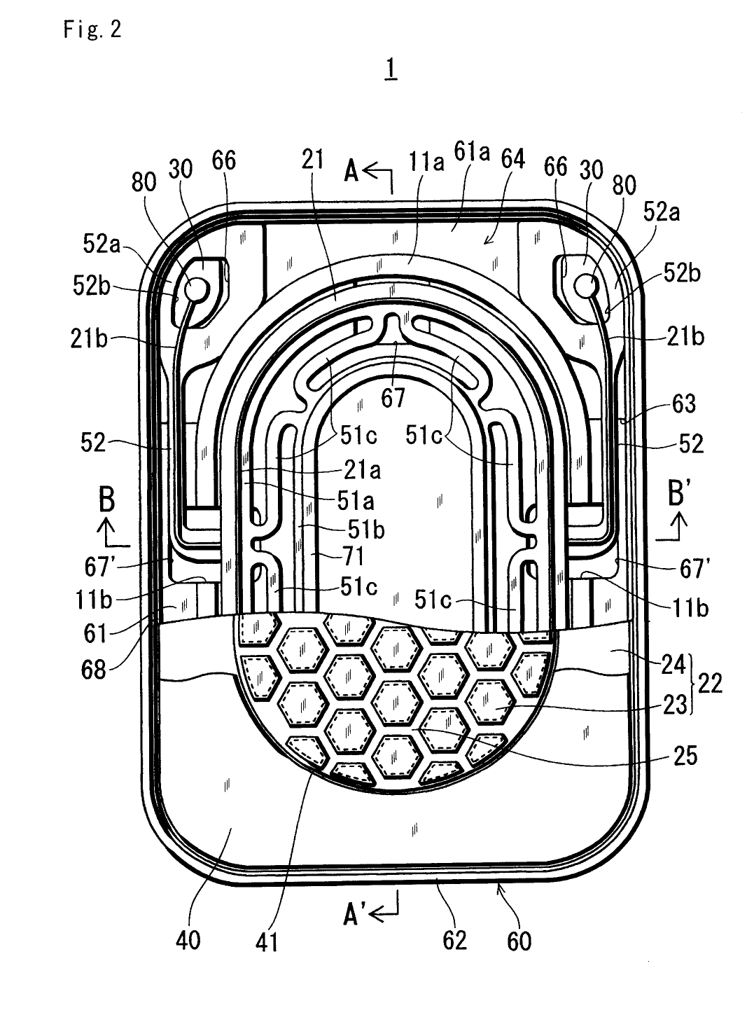

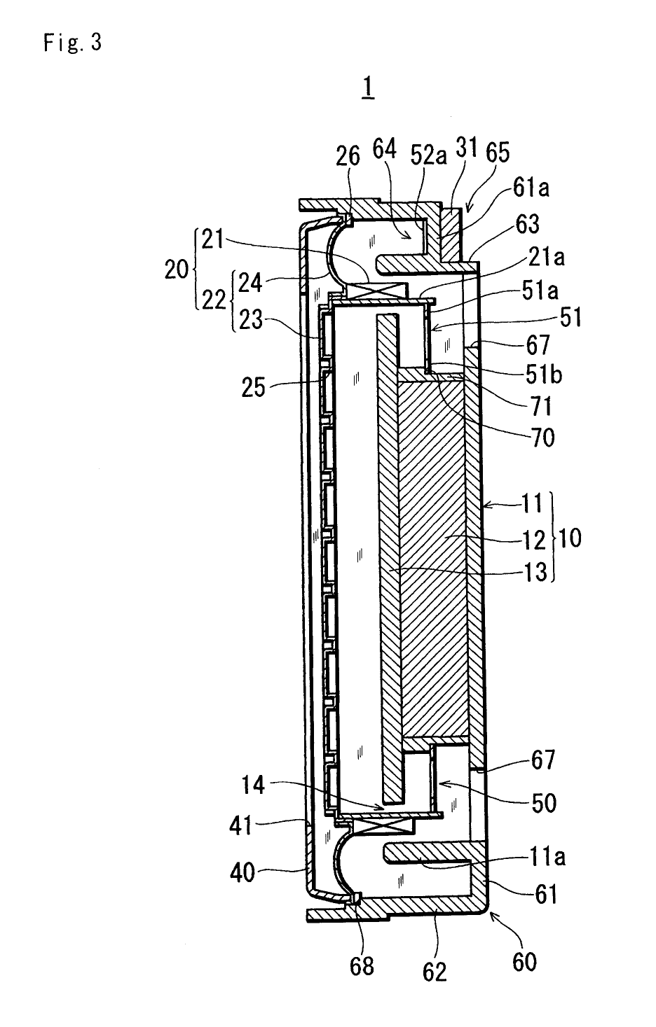

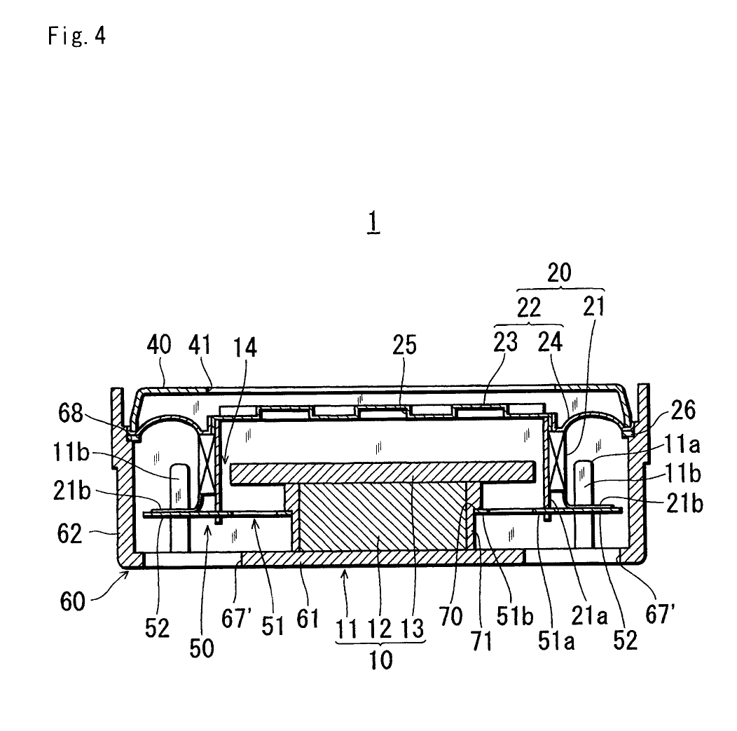

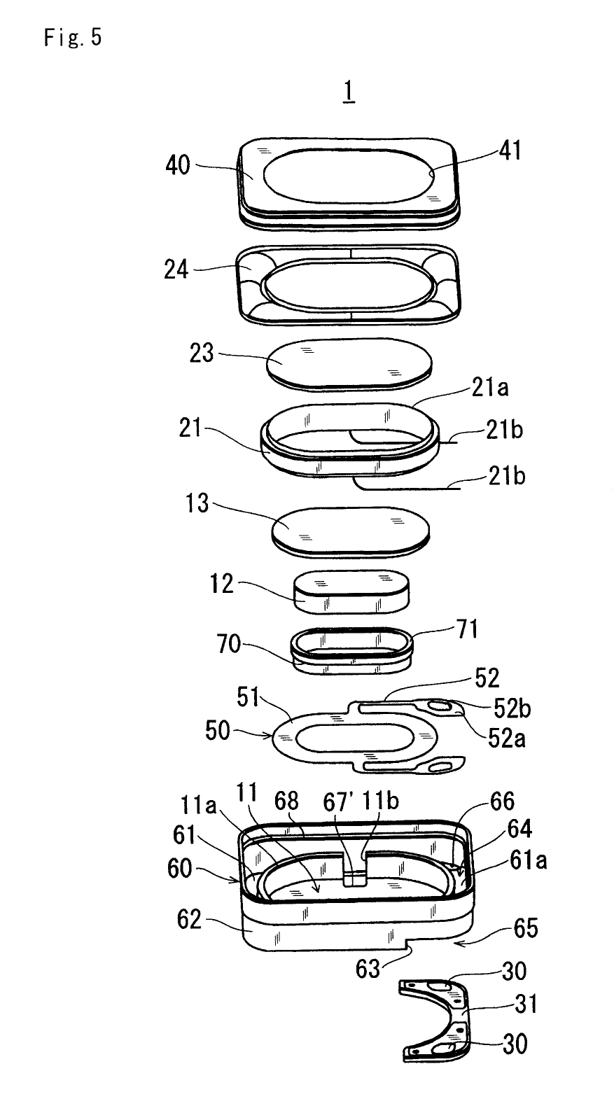

Hereinafter, an embodiment (Embodiment 1) of the invention will be described with reference to FIGS. 1A to 5. FIGS. 1A to 1C are views illustrating a speaker damper of the embodiment (Embodiment 1) of the invention, FIG. 1A is a plan view of the speaker damper, FIG. 1B is a sectional view taken along line A-A′ in FIG. 1A, FIG. 1C is a sectional view taken along line B-B′ in FIG. 1A, FIG. 2 is a plan view of a speaker including the speaker damper shown in FIGS. 1A to 1C, FIG. 3 is a sectional view taken along line A-A′ in FIG. 2, FIG. 4 is a sectional view taken along line B-B′ in FIG. 2, and FIG. 5 is an exploded perspective view of the speaker of FIG. 2.

As shown in FIGS. 2 to 5, the speaker 1 is mainly configured by: a yoke 11, magnet 12, and pole piece 13 which constitute a magnetic circuit 10; a voice coil 21 and diaphragm 22 which constitute a vibration system 20; an external connection plate 31 on which a pair of external connection terminals 30 to be electrically connected to an external circuit are disposed; a baffle 40 which covers and protects the diaphragm 22; a damper (speaker damper) 50 of the invention; and a frame 60 to which the magnetic circuit 10, the vibration system 20, the external connection plate 31, and the damper 50 are attached to assemble the speaker 1, and which cooperates with the baffle 40 to constitute a case of the speaker 1.

The frame 60 is formed into a shallow bottomed rectangular tubular shape by perpendicularly raising an outer sidewall 62 from the outer peripheral edge of a rectangle bottom plate 61. The yoke 11 is integrally formed in a middle portion of the frame. Namely, an oval yoke outer sidewall 11a is perpendicularly raised from the inner surface of a middle portion of the bottom plate 61, and the middle portion of the bottom plate 61 which is inside the yoke outer sidewall 11a is used as a yoke bottom plate, thereby forming the bottomed oval cylindrical yoke 11 which is shallower than the frame 60, and which is concentric with the frame 60.

In the bottom plate 61, a step 63 is formed in order to raise by one step a bottom plate 61a which is in the bottom plate 61 surrounding the yoke 11, and which is in the periphery of one semi-arcuate end portion of the yoke 11. In one end portion (in FIG. 2, an upper end portion) in the longitudinal direction (in FIG. 2, the vertical direction) of the frame 60, a raised bottom portion 64 which functions as a lead portion support portion of the damper 50 is disposed, and a recess portion 65 functioning as a portion to which the external connection plate is to be attached is disposed on the outer bottom face of an end portion in the longitudinal direction of the frame 60 that is the rear side of the raised bottom portion 64. Through holes 66 functioning as connecting portions between the pair of external connection terminals 30 placed outside the frame 60, and two voice coil lead wires 21b placed inside the frame 60 are disposed in both end portions of the bottom plate 61a of the raised bottom portion 64, respectively.

Four voice coil positioning pins (not shown) are used for, during assembly of the speaker 1, holding and positioning the voice coil 21 in a total of four places, i.e., two places on the longitudinal direction center line, and two places on the short-side direction center line (in FIG. 2, the lateral direction). In the bottom plate 61, through holes 67, 67′ for inserting the four voice coil positioning pins from the bottom side of the frame 60 into the interior thereof are disposed in a total of four places corresponding to the insertion positions of the four voice coil positioning pins, i.e., two places on the longitudinal direction center line of the frame 60, and two places on the short-side direction center line.

During use of the speaker 1, the through holes 67, 67′ function as rear sound holes through which air (sound) that is in the frame 60, and that is pressed by the diaphragm 22 escapes to the outside. The two through holes 67 on the longitudinal direction center line of the frame 60 are disposed in the bottom plate 61 which functions as the yoke bottom plate inside the yoke outer sidewall 11a, and mainly used for allowing air pressed by a diaphragm middle portion 23 of the diaphragm 22 to escape, and the two through holes 67′ on the short-side direction center line of the frame 60 are disposed in the both portions of the bottom plate 61 outside and inside the yoke outer sidewall 11a, and used for allowing air pressed not only by the diaphragm middle portion 23 of the diaphragm 22 but also by a diaphragm edge portion 24 to escape.

Discontinued portions 11b functioning as voice coil lead-wire drawn out ports are disposed in two places on the short-side direction center line of the yoke outer sidewall 11a, respectively. In the two discontinued portions 11b, the two through holes 67′ on the short-side direction center line of the frame 60 are disposed in the both portions of the bottom plate 61 outside and inside the yoke outer sidewall 11a.

A horizontal step face 68 which functions as a support face for the vibration system 20 is disposed in the upper inner face of the outer sidewall 62.

The yoke-integral type frame 60 is formed by performing a press process on one flat metal plate (magnetic material), and has an axisymmetric structure in which the short-side direction center line is set as the symmetric axis.

The magnet 12 is configured by a long columnar permanent magnet. The pole piece 13 is configured by an oval flat metal plate (magnetic material). The magnet 12 is bonded and fixed to the inner bottom face of the yoke 11, and the pole piece 13 is bonded and fixed to the upper face of the magnet 12, thereby configuring the oval magnetic circuit 10 of the internal magnet type. The magnetic circuit 10 forms an oval magnetic gap 14 between an upper portion of the yoke outer sidewall 11a and the pole piece 13.

The voice coil 21 is formed into an oval cylindrical shape by winding a copper wire or the like around the outer peripheral face of an oval cylindrical voice coil bobbin 21a made of a plastic film or the like. The voice coil lead wires 21b for electrically connecting the voice coil 21 to the external connection terminals 30 are connected to both end portions of the winding, respectively. The voice coil lead wires 21b are drawn out from two places of a lower end portion of the voice coil 21 and on the short-side direction center line of the voice coil 21.

The diaphragm 22 is configured by a thin film such as a plastic film of polyethylene terephthalate (PET), polyetherimide (PEI), polyimide (PI), or the like. The diaphragm 22 has an oval diaphragm middle portion 23 which covers the upper end opening of the voice coil 21, and the diaphragm edge portion 24 which surrounds the whole circumference of the diaphragm middle portion 23, and in which the outer shape is formed into a rectangular shape so as to coincide with that of the frame 60. The diaphragm 22 is formed by separately forming the diaphragm middle portion 23 and the diaphragm edge portion 24, and then bonding and fixing together an outer peripheral edge portion of the diaphragm middle portion 23 and an inner peripheral edge portion of the diaphragm edge portion 24. Alternatively, the diaphragm 22 may be formed by integrally forming the diaphragm middle portion 23 and the diaphragm edge portion 24. A honeycomb-like reinforcement rib 25 is formed on the whole face of the diaphragm middle portion 23, so that the whole face of the diaphragm middle portion 23 is uniformly reinforced, and the diaphragm middle portion 23 is provided with necessary strength (rigidity) while the diaphragm middle portion 23 is thinned (finally flattened from a dome-like shape to a flat plate-like shape), thereby realizing thinning of the speaker 1. The illustrated reinforcement rib 25 is formed into a groove-like shape in which the upper face of the diaphragm middle portion 23 is concave and the lower face is convex. Alternatively, the reinforcement rib may be formed into a bulge-like shape in which the upper face of the diaphragm middle portion 23 is convex and the lower face is concave. A rectangular diaphragm ring 26 which is made of a metal such as brass, and which functions as a washer is bonded and fixed to the rear side of an outer peripheral edge portion of the diaphragm edge portion 24.

The vibration system 20 is configured by bonding and fixing the rear side of the interface between the diaphragm middle portion 23 of the diaphragm 22 and the diaphragm edge portion 24 to an upper end portion of the voice coil bobbin 21a, and hangingly fixing the voice coil 21 to the rear side of the interface between the diaphragm middle portion 23 of the diaphragm 22 and the diaphragm edge portion 24 through the voice coil bobbin 21a.

The vibration system 20 is held by coupling its upper end portion to the frame 60 which is the stationary portion of the speaker 1 by means of the diaphragm edge portion 24. Namely, the outer peripheral edge portion of the diaphragm edge portion 24 is bonded and fixed through the diaphragm ring 26 to the step face 68 which is disposed on the inner face of the upper portion of the outer sidewall 62 as the support face for the vibration system 20, whereby the diaphragm 22 is disposed there so as to cover the upper opening of the frame 60. The voice coil 21 is inserted and placed in the magnetic gap 14 from the upper side. The diaphragm edge portion 24 plays a role of holding the vibration system 20 to the correct position to realize accurate vibration of the vibration system 20.

The external connection plate 31 is a printed circuit board in which two external connection terminals 30 are integrally disposed in an insulated state. The plate is attached to the recess portion 65 of the frame 60, and one-end sides of the external connection terminals 30 are exposed through the through holes 66 to the both end portions of the inner bottom face of the raised bottom portion 64, respectively. The other end sides of the external connection terminals 30 are exposed to the rear side of the external connection plate 31 in a substantially flush manner, and electrically connected to an external circuit (printed circuit board) of an electronic apparatus such as a portable telephone onto which the speaker 1 is mounted.

The baffle 40 is formed by applying a pressing process on a metal flat plate, into a ceiled rectangular tubular shape which is shallower than the frame 60, and fitted to the upper opening of the frame 60 to cover and protect the the diaphragm 22. The lower end of the outer side wall of the baffle 40 presses and fixes from the upper side the outer peripheral edge portion of the diaphragm edge portion 24 and the diaphragm ring 26 against the step face 68. A front sound hole 41 having a substantially same shape as the diaphragm middle portion 23 is disposed in the top plate of the baffle 40. To the outer top face of the baffle 40 and the outer bottom face of the frame 60, damping cloth (not shown) having air permeability is bonded in order to cover the front sound hole 41 and rear sound holes (through holes 67, 67′) which are formed in the faces, adjust the acoustic performance of the speaker 1, and prevent dust from entering the interior of the speaker 1.

The speaker 1 includes: the magnetic circuit 10 having the yoke 11, the magnet 12, and the pole piece 13; the vibration system 20 having the voice coil 21 and diaphragm 22 which are connected to each other through the voice coil bobbin 21a; and the frame 60 which holds the magnetic circuit 10 and the vibration system 20, and the voice coil 21 is placed in the magnetic gap 14, thereby configuring the dynamic speaker 1.

In the dynamic speaker 1, when, in a state where the voice coil lead wires 21b are connected to the external connection terminals 30 inside the frame 60, a current is supplied from the external circuit to the voice coil 21 through the external connection terminals 30 and the voice coil lead wires 21b, the voice coil 21 is caused to perform vertical piston motion or vibrate by an interaction between the magnetic fluxes which are directed in a substantially horizontal direction in the magnetic gap 14, and the current flowing through the voice coil 21. The vibration is transmitted to the diaphragm 22 by the voice coil bobbin 21a, and the diaphragm middle portion 23 vibrates while setting the diaphragm edge portion 24 as a fulcrum, thereby generating a sound. Namely, the speaker converts electricity into a sound.

The damper 50 is disposed in the speaker 1 in order to cooperate with the diaphragm edge portion 24 to play a role of holding the vibration system 20 to a correct position to realize accurate vibration of the vibration system 20. The damper is configured so that the voice coil lead wires 21b are laid on one surface to be guided to the external connection terminals 30.

As shown in FIGS. 1A, 1B, and 1C, the damper body 51 which exerts a damper function, and a pair of lead portions 52 for guiding the two voice coil lead wires 21b to the external connection terminals 30 to which the wires are to be connected are disposed in the damper 50. The damper body 51 and the lead portions 52 are placed in one plane. The damper 50 is formed by performing a punching process on one sheet-like member (non-magnetic material) such as a plastic film of polyethylene terephthalate (PET), polyetherimide (PEI), polyimide (PI), or the like, and has a planar structure.

In the damper body 51, an outer ring portion 51a that is a movable portion which is coupled to a lower end portion of the voice coil bobbin 21a opposite to the diaphragm 22, an inner ring portion 51b that is a fixed portion coupled to the magnet 12 of the magnetic circuit 10 which is a stationary portion of the speaker 1, and flexible portions 51c through which the outer ring portion 51a and the inner ring portion 51b are connected to each other are disposed. The damper body is configured so as to support the vibration system 20 with respect to the magnet 12 of the magnetic circuit 10.

The outer ring portion 51a is formed into an oval annular member which has a constant width over the whole circumference, so as to cause the outer peripheral end face of the outer ring portion 51a to contact with the inner peripheral face of the voice coil bobbin 21a, or the one surface of the outer ring portion 51a to contact with the lower end face of the voice coil bobbin 21a.

The inner ring portion 51b is formed into an oval annular member which has a constant width that is substantially equal to that of the outer ring portion 51a, over the whole circumference, which is smaller than the outer ring portion 51a, and which is concentric with the outer ring portion 51a, so as to cause the inner peripheral end face of the inner ring portion 51b to contact with the outer peripheral face of the magnet 12, or the one surface of the inner ring portion 51b to contact with a horizontal step face 70 which is disposed as an upward or downward inner ring portion bonding portion on the outer peripheral face of the magnet 12. The gap between the outer ring portion 51a and the inner ring portion 51b is constant over the whole circumference.

When the step face 70 is disposed directly on the outer peripheral face of the magnet 12, the production cost of the magnet 12 is high. Therefore, an oval cylindrical damper ring 71 made of plastic (non-magnetic material) or the like is disposed, the step face 70 is disposed on the outer peripheral face of the damper ring 71, and the damper ring 71 is fitted onto the magnet 12, whereby the step face 70 is disposed on the outer peripheral face of the magnet 12.

The flexible portions 51c are configured by a plurality (in the illustrated example, eight) of flexurally deformable plate spring-like members which are bent in a crank-like manner in one plane, and which have a constant width that is substantially equal to the widths of the outer ring portion 51a and the inner ring portion 51b over the whole circumference. Intermediate portions of the flexible portions 51c are placed along an oval center line which is drawn between the outer ring portion 51a and the inner ring portion 51b, and which is concentric therewith. Outward ends of the flexible portions 51c are coupled to the inner peripheral edge of the outer ring portion 51a, and the inward other ends of the flexible portions 51c are coupled to the outer peripheral edge of the inner ring portion 51b. The flexible portions 51c cause the outer ring portion 51a and the inner ring portion 51b to be connected to each other at a plurality (in the illustrated example, eight) of places which are shifted in the circumferential direction of the damper body 51. The connection pattern between the outer ring portion 51a and the inner ring portion 51b through the flexible portions 51c is formed into a shape which does not cause the damper performance to be unbalanced depending on the circumferential position of the damper body 51. Namely, the pattern has a symmetrical shape such as an axisymmetrical shape in which the center line in the longitudinal direction center line (in FIG. 1A, the vertical direction) or short-side direction center line (in FIG. 1A, the lateral direction) of the damper body 51 is set as the symmetrical axis, or a point (rotational) symmetrical shape in which the center of the damper body 51 is set as the symmetry center. In the illustrated example, the pattern has an axisymmetrical shape in which any of the center lines in the longitudinal direction and short-side direction of the damper body 51 can be set as the symmetrical axis, and a 180-degree point symmetrical shape in which the center of the damper body 51 is set as the symmetry center.

Each of the paired lead portions 52 is configured by a flexurally deformable thin plate spring-like member which is bent into an L-like shape in one plane. The lead portions are elongated respectively from two places on the short-side direction center line of the outer peripheral edge of the outer ring portion 51a to both end portions of the raised bottom portion 64 which are disposed as lead portion supporting portions for the damper 50 in one end portion in the longitudinal direction of the frame 60, while passing through the discontinued portions 11b which are disposed in two places on the short-side direction center line of the yoke outer sidewall 11a, and between the yoke outer sidewall 11a and the outer sidewall 62 of the frame 60.

In tip end portions of the lead portions 52, formed are ring portions 52a which surround the through holes 66 that are disposed in both end portions of the bottom plate 61a of the raised bottom portion 64 as connecting portions between the pair of external connection terminals 30 placed outside the frame 60, and the two voice coil lead wires 21b placed inside the frame 60, which are to be bonded and fixed to the inner surface of the raised bottom portion 64 surrounding the through holes 66.

Bonding layers 52c (the hatched portions in FIG. 1A) are disposed on one surfaces (upper faces) of the lead portions 52 in order to bond and fix the voice coil lead wires 21b. Each of the bonding layers 52c has a linear shape which is continuous from a basal end portion of the corresponding lead portion 52 coupled to the outer ring portion 51a, to an inner hole 52b of the corresponding ring portion 52a that is formed in a tip end portion of the lead portion 52, or a broken line like shape in which one or more interrupted parts are formed. The bonding layers 52c are formed by, for example, application of an adhesive material.

The lead portions 52 are elongated from the damper body 51 in an axisymmetrical shape in which the center line in the longitudinal direction of the damper body 51 is set as the symmetrical axis. The damper 50 has as a whole an axisymmetric structure in which the longitudinal-direction center line of the damper body 51 is set as the symmetrical axis.

As shown in FIGS. 2 to 4, the vibration system 20 in which the upper end portion is connected and held to the frame 60 that is the stationary portion of the speaker 1 by the diaphragm edge portion 24 is further connected and held in the lower end portion by the damper 50 to the magnet 12 of the magnetic circuit 10 that is the stationary portion of the speaker 1. Namely, the damper body 51 is horizontally stretched between the lower end portion of the voice coil bobbin 21a and the magnet 12 by: bonding and fixing the outer peripheral end face of the outer ring portion 51a to the inner peripheral face of the voice coil bobbin 21a; bonding and fixing the one surface (upper face) of the outer ring portion 51a to the lower end face of the voice coil bobbin 21a, and the inner peripheral end face of the inner ring portion 51b to the outer peripheral face of the magnet 12; or bonding and fixing the one surface (upper face) of the inner ring portion 51b to the upward or downward step face 70 which is disposed on the outer peripheral face of the magnet 12 through the damper ring 71, whereby the damper body 51 is enabled to exert a damper function.

At this time, the lead portions 52 are elongated respectively to the end portions of the raised bottom portion 64 from the two places on the short-side direction center line of the outer peripheral edge of the outer ring portion 51a, while passing through the discontinued portions 11b which are disposed in two places on the short-side direction center line of the yoke outer sidewall 11a, and between the yoke outer sidewall 11a and the outer sidewall 62 of the frame 60. Therefore, the lead portions 52 are horizontally stretched between the two places on the short-side direction center line of the outer peripheral edge of the outer ring portion 51a, and the end portions of the raised bottom portion 64, in the same plane as the damper body 51, by bonding and fixing the ring portions 52a which are formed in the tip end portions of the lead portions 52, to the inner surface of the raised bottom portion 64 surrounding the through holes 66 disposed in the both end portions of the bottom plate 61a of the raised bottom portion 64, so that the two voice coil lead wires 21b are guided by the lead portions 52 to the external connection terminals 30 to which the wires are to be connected.

Namely, the configuration where the two voice coil lead wires 21b which are drawn out from the two places of the lower end portion of the voice coil 21 that are directly above the basal end portions of the lead portions 52, and on the short-side direction center line of the voice coil 21 are bonded and fixed to the bonding layers 52c disposed on the one surfaces (upper faces) of the lead portions 52 allows the two voice coil lead wires 21b to be bent into an L-like shape along the lead portions 52, and to be guided from the two places on the short-side direction center line of the outer peripheral edge of the outer ring portion 51a, to the end portions of the raised bottom portion 64, while passing through the discontinued portions 11b which are disposed in two places on the short-side direction center line of the yoke outer sidewall 11a, and between the yoke outer sidewall 11a and the outer sidewall 62 of the frame 60. In this way, the process of laying the voice coil lead wires 21b by means of forming to the external connection terminals 30 to which the wires are to be connected is realized not in the air of the interior of the speaker 1, but on the one surfaces of the lead portions 52 disposed in the damper body 51.

When the voice coil lead wires 21b are bonded and fixed to the bonding layers 52c of the lead portions 52, enough slacks are provided between the end portions of the voice coil lead wires 21b on the drawn out side from the voice coil 21, and the portions where the lead portions 52 are bonded and fixed to the bonding layers 52c, in order to allow and not to impeded the voice coil 21 to vibrate.

After the laying process by means of forming, the two voice coil lead wires 21b are connected by soldering or spot welding 80 to one end sides of the external connection terminals 30 which are exposed in the both end portions of the inner bottom face of the raised bottom portion 64 through the inner holes 52b of the ring portions 52a that are formed in the tip end portions of the lead portions 52, and the through holes 66 that are disposed in the both end portions of the bottom plate 61a of the raised bottom portion 64.

The lead portions 52 exert not only a function of, in the assembling of the speaker 1, guiding the two voice coil lead wires 21b to the external connection terminals 30 to which the wires are to be connected, but also the following functions. During the use of the speaker 1, the tip end portions (ring portions 52a) of the lead portions 52 function as a fixed portion coupled to the frame 60 which is a stationary portion of the speaker 1, and the areas of the lead portions 52 from the basal end portions to the tip end portions function as a flexible portion through which the outer ring portion 51a functioning as a movable portion coupled to the end portion of the voice coil bobbin 21a opposite to the diaphragm 22, and the tip end portions (ring portions 52a) of the lead portions 52 functioning as the fixed portion coupled to the frame 60 which is a stationary portion of the speaker 1 are coupled to each other, with the result that a damper function is exerted.

As described above, the damper 50 is used in the speaker including: the magnetic circuit 10 having the yoke 11, the magnet 12, and the pole piece 13; the vibration system 20 having the voice coil 21 and diaphragm 22 which are connected to each other through the voice coil bobbin 21a; and the frame 60 which holds the magnetic circuit 10, the vibration system 20, and the external connection terminals 30, the voice coil 21 being placed in the magnetic gap 14, and the voice coil lead wires 21b are guided to the external connection terminals 30 while being laid on the one surface. In the embodiment, the lead portions 52 which are elongated from the damper body 51 to the external connection terminals 30, and in which the voice coil lead wires 21b are bonded and fixed to the one surface to be guided to the external connection terminals 30 are disposed, and the process of laying the voice coil lead wires 21b by means of forming is realized not in the air of the interior of the frame 60, but on the one surfaces of the lead portions 52 disposed in the damper body 51, or by bonding and fixing the voice coil lead wires 21b to the one surfaces of the lead portions 52. Therefore, the process of laying the voice coil lead wires 21b by means of forming can be performed easily and properly, the forming of the voice coil lead wires 21b can be stabilized, and the positional accuracy of the voice coil lead wires 21b with respect to the external connection terminals 30 can be improved, so that improvement of the productivity of the speaker 1 can be realized. The flex resistance of the voice coil lead wires 21b can be improved, and also improvement of the input resistance characteristics of the speaker 1 can be realized.

In the damper body 51, the movable portion 51a which is coupled to the end portion of the voice coil bobbin 21a opposite to the diaphragm 22, the fixed portion 51b which is coupled to the stationary portion (the frame 60 and the magnetic circuit 10) of the speaker 1, and the flexible portions 51c through which the movable portion 51a and the fixed portion 51b are connected to each other are disposed, and the lower end of the vibration system 20 which has the maximum distance from the diaphragm edge portion 24 is supported by the damper body 51. Therefore, a high damper performance can be obtained. Moreover, two points, i.e., the upper and lower ends of the vibration system 20 are supported by the diaphragm edge portion 24 and the damper body 51, and hence the vibration system 20 can produce more stable and accurate vibration. Therefore, the input resistance characteristics of the speaker 1 can be further improved.

In the damper body 51, the outer ring portion 51a functioning as the movable portion which is coupled to the end portion of the voice coil bobbin 21a opposite to the diaphragm 22, the inner ring portion 51b functioning as the fixed portion which is coupled to the magnet 12 of the magnetic circuit 10 functioning as the stationary portion of the speaker, and the flexible portions 51c through which the outer ring portion 51a and the inner ring portion 51b are connected to each other are disposed, and the vibration system 20 is supported with respect to the magnet 12. The lead portions 52 are elongated from the outer ring portion 51a. The damper body 51 can be disposed by effectively using the space between the pole piece 13 and the yoke 11, and without particularly ensuring a space. Therefore, the speaker 1 can be further thinned, and the input resistance characteristics of the speaker 1 can be further improved.

Moreover, the damper body 51 and the lead portions 52 are placed in the one plane, and the process of laying the voice coil lead wires 21b by means of forming is realized by bonding and fixing the voice coil lead wires 21b to the one flat surfaces of the lead portions 52. Therefore, the process of laying the voice coil lead wires 21b by means of forming can be performed easily and properly, so that improvement of the productivity of the speaker 1, further thinning of the speaker 1, and further improvement of the input resistance characteristics of the speaker 1 can be realized.

Furthermore, the damper 50 is formed by performing a punching process on one sheet-like member, and has a planar structure. Therefore, the damper 50 which can realize improvement of the productivity, thinning, and improvement of the input resistance characteristics of the speaker 1 can be economically obtained.

Furthermore, the speaker 1 includes the damper 50 of the embodiment, and hence it is possible to realize a thin speaker which has a high productivity and a high input resistance.

### Embodiment 2

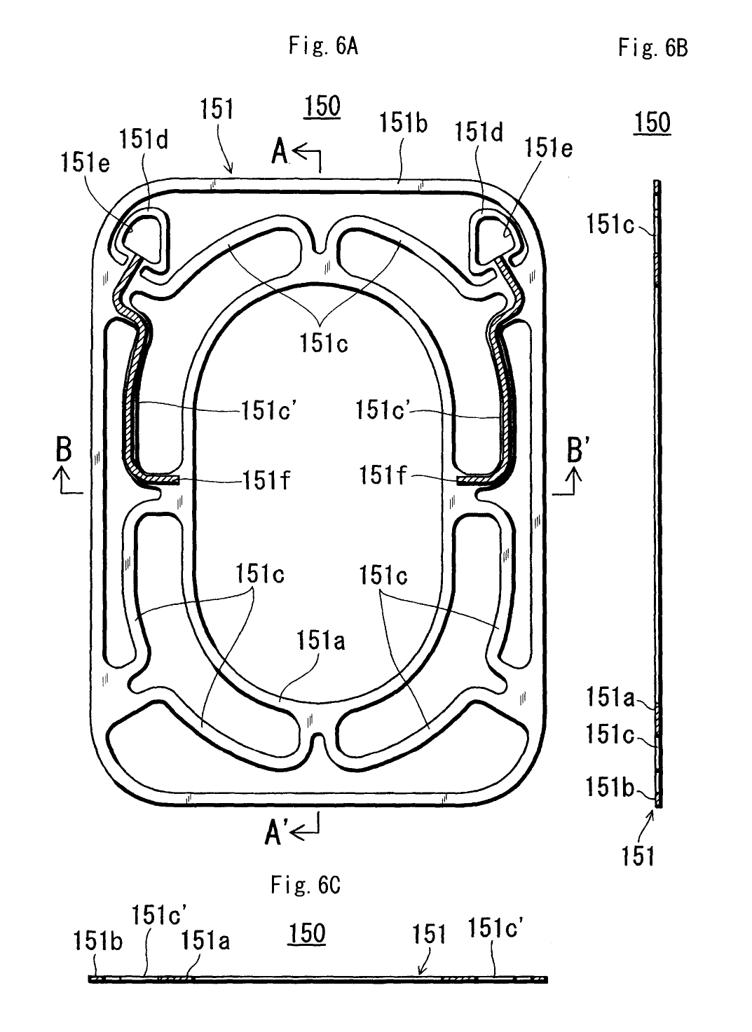

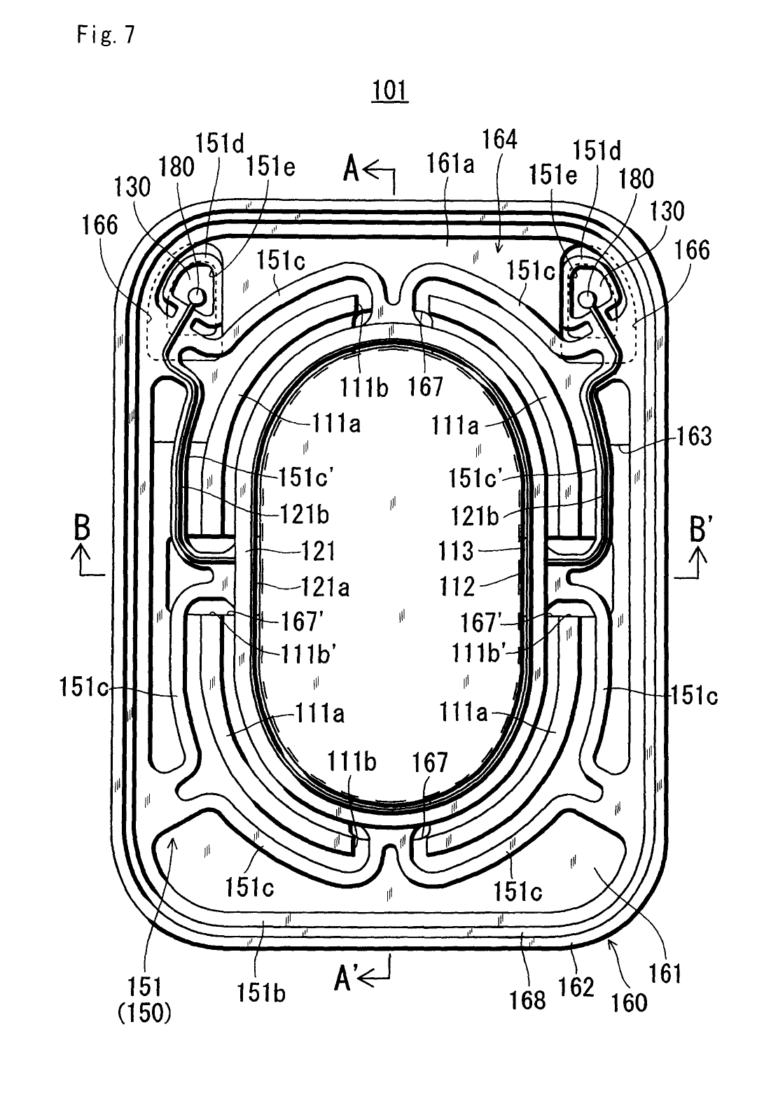

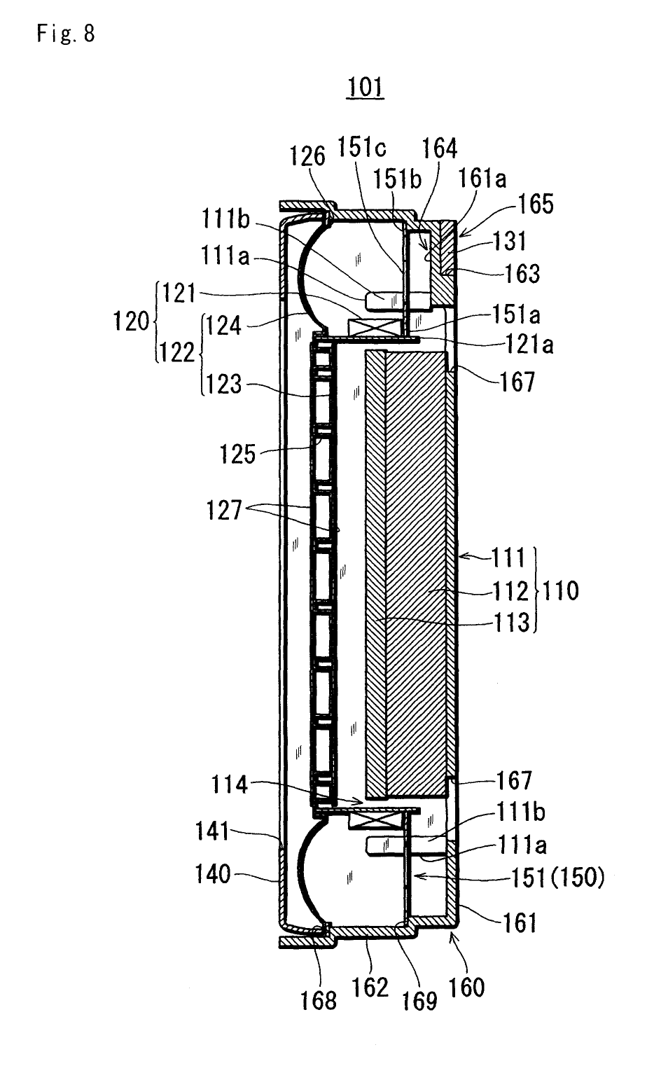

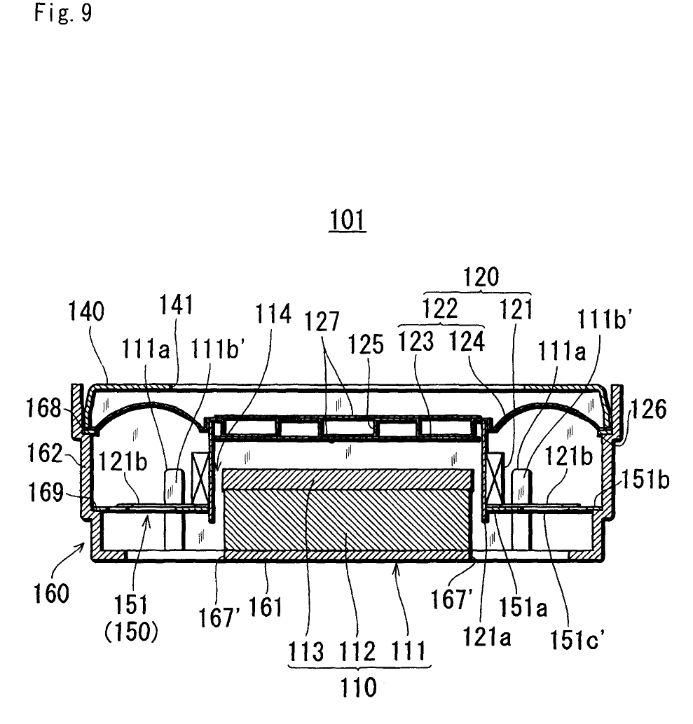

Next, another embodiment (Embodiment 2) of the invention will be described with reference to FIGS. 6A to 9. FIGS. 6A to 6C are views illustrating another speaker damper of the other embodiment (Embodiment 2) of the invention, FIG. 6A is a plan view of the other speaker damper, FIG. 6B is a sectional view taken along line A-A′ in FIG. 6A, FIG. 6C is a sectional view taken along line B-B′ in FIG. 6A, FIG. 7 is a plan view of another speaker including the other speaker damper shown in FIGS. 6A to 6C, FIG. 8 is a sectional view taken along line A-A′ in FIG. 7, and FIG. 9 is a sectional view taken along line B-B′ in FIG. 7.

As shown in FIGS. 7 to 9, the other speaker 101 is mainly configured by: a yoke 111, magnet 112, and pole piece 113 which constitute a magnetic circuit 110; a voice coil 121 and diaphragm 122 which constitute a vibration system 120; an external connection plate 131 on which a pair of external connection terminals 130 to be electrically connected to an external circuit are disposed; a baffle 140 which covers and protects the diaphragm 122; another damper (other speaker damper) 150 of the invention; and a frame 160 to which the magnetic circuit 110, the vibration system 120, the external connection plate 131, and the other damper 150 are attached to assemble the other speaker 101, and which cooperates with the baffle 140 to constitute a case of the other speaker 1.

The frame 160 is formed into a shallow bottomed rectangular tubular shape by perpendicularly raising an outer sidewall 162 from the outer peripheral edge of a rectangle bottom plate 161. The yoke 111 is integrally formed in a middle portion of the frame. Namely, an oval yoke outer sidewall 111a is perpendicularly raised from the inner surface of a middle portion of the bottom plate 161, and the middle portion of the bottom plate 161 which is inside the yoke outer sidewall 111a is used as a yoke bottom plate, thereby forming the bottomed oval cylindrical yoke 111 which is shallower than the frame 160, and which is concentric with the frame 160.

In the bottom plate 161, a step 163 is formed in order to raise by one step a bottom plate 161a which is in the bottom plate 161 surrounding the yoke 111, and which is in the periphery of one semi-arcuate end portion of the yoke 111. In one end portion (in FIG. 7, an upper end portion) in the longitudinal direction (in FIG. 7, the vertical direction) of the frame 160, a raised bottom portion 164 is disposed, and a recess portion 165 functioning as a portion to which the external connection plate is to be attached is disposed on the outer bottom face of an end portion in the longitudinal direction of the frame 160 that is the rear side of the raised bottom portion 164. Through holes 166 functioning as connecting portions between the pair of external connection terminals 130 placed outside the frame 160, and two voice coil lead wires 121b placed inside the frame 160 are disposed in both end portions of the bottom plate 161a of the raised bottom portion 164, respectively.

Four voice coil positioning pins (not shown) are used for, during assembly of the speaker 101, holding and positioning the voice coil 121 in a total of four places, i.e., two places on the longitudinal direction center line, and two places on the short-side direction center line (in FIG. 7, the lateral direction). In the bottom plate 161, through holes 167, 167′ for inserting the four voice coil positioning pins from the bottom side of the frame 160 into the interior thereof are disposed in a total of four places corresponding to the insertion positions of the four voice coil positioning pins, i.e., two places on the longitudinal direction center line of the frame 160, and two places on the short-side direction center line.

During use of the speaker 101, the through holes 167, 167′ function as rear sound holes through which air (sound) that is in the frame 160, and that is pressed by the diaphragm 122 escapes to the outside. The two through holes 167 on the longitudinal direction center line of the frame 160 are disposed in the bottom plate 161 which functions as the yoke bottom plate inside the yoke outer sidewall 111a, and mainly used for allowing air pressed by a diaphragm middle portion 123 of the diaphragm 122 to escape, and the two through holes 167′ on the short-side direction center line of the frame 160 are disposed in the both portions of the bottom plate 161 outside and inside the yoke outer sidewall 111a, and used for allowing air pressed not only by the diaphragm middle portion 123 of the diaphragm 122 but also by a diaphragm edge portion 124 to escape.

Discontinued portions 111b, 111b′ are disposed in a total of four places, i.e., two places on the longitudinal direction center line of the yoke outer sidewall 111a, and two places on the short-side direction center line, respectively. The two discontinued portions 111b on the longitudinal direction center line of the yoke outer side-wall 111a function as passing portions for flexible portions 151c through which an inner ring portion 151a of the damper 150 and an outer ring portion 151b are connected to each other. The two discontinued portions 111b′ on the short-side direction center line of the yoke outer side-wall 111a function as passing portions for the flexible portions 151c through which the inner ring portion 151a of the damper 150 and the outer ring portion 151b are connected to each other, and also as voice coil lead-wire drawn out ports. The two through holes 167 on the longitudinal direction center line of the frame 160 are inside the two discontinued portions 111b on the longitudinal direction center line of the yoke outer sidewall 111a. In the two discontinued portions 111b′ on short-side direction center line of the yoke outer sidewall 111a, the two through holes 167′ on the short-side direction center line of the frame 160 are disposed in the both portions of the bottom plate 161 outside and inside the yoke outer side-wall 111a.

A horizontal upper step face 168 which functions as an upper support face for the vibration system 120 is disposed in the upper inner face of the outer sidewall 162. A horizontal lower step face 169 which functions as a lower support face for the vibration system 120 is disposed in the lower inner face of the outer sidewall 162. The lower step face 169 is formed to be slightly smaller than the upper step face 168.

The yoke-integral type frame 160 is formed by performing a press process on one flat metal plate (magnetic material), and has an axisymmetric structure in which the short-side direction center line is set as the symmetric axis.

The magnet 112 is configured by a long columnar permanent magnet. The pole piece 113 is configured by an oval flat metal plate (magnetic material). The magnet 112 is bonded and fixed to the inner bottom face of the yoke 111, and the pole piece 113 is bonded and fixed to the upper face of the magnet 112, thereby configuring the oval magnetic circuit 110 of the internal magnet type. The magnetic circuit 110 forms an oval magnetic gap 114 between an upper portion of the yoke outer sidewall 111a and the pole piece 113.

The voice coil 121 is formed into an oval cylindrical shape by winding a copper wire or the like around the outer peripheral face of an oval cylindrical voice coil bobbin 121a made of a plastic film or the like. The voice coil lead wires 121b for electrically connecting the voice coil 121 to the external connection terminals 130 are connected to both end portions of the winding, respectively. The voice coil lead wires 121b are drawn out from two places of a lower end portion of the voice coil 121 and on the short-side direction center line of the voice coil 121.

The diaphragm 122 is configured by a thin film such as a plastic film of polyethylene terephthalate (PET), polyetherimide (PEI), polyimide (PI), or the like. The diaphragm 122 has an oval diaphragm middle portion 123 which covers the upper end opening of the voice coil 121, and the diaphragm edge portion 124 which surrounds the whole circumference of the diaphragm middle portion 123, and in which the outer shape is formed into a rectangular shape so as to coincide with that of the frame 160. The diaphragm 122 is formed by separately forming the diaphragm middle portion 123 and the diaphragm edge portion 124, and then bonding and fixing together an outer peripheral edge portion of the diaphragm middle portion 123 and an inner peripheral edge portion of the diaphragm edge portion 124. Alternatively, the diaphragm 122 may be formed by integrally forming the diaphragm middle portion 123 and the diaphragm edge portion 124. A honeycomb-like reinforcement rib 125 is formed on the whole face of the diaphragm middle portion 123, so that the whole face of the diaphragm middle portion 123 is uniformly reinforced, and the diaphragm middle portion 123 is provided with necessary strength (rigidity) while the diaphragm middle portion 123 is thinned (finally flattened from a dome-like shape to a flat plate-like shape), thereby realizing thinning of the other speaker 101. The illustrated reinforcement rib 125 is formed into a bulge-like shape in which the upper face of the diaphragm middle portion 123 is convex and the lower face is concave. Alternatively, the reinforcement rib may be formed into a groove-like shape in which the upper face of the diaphragm middle portion 123 is concave and the lower face is convex. A surface member 127 which is configured by a metal foil such as an aluminum foil, or a thin film of a plastic film or the like such as PET, PEI, or PI is bonded to each of the upper and lower faces of the diaphragm middle portion 123 as a reinforcing member which further reinforces the diaphragm middle portion 123. Alternatively, the surface member 127 may be bonded to only one of the upper and lower faces of the diaphragm middle portion 123. It is matter of course that the surface member 127 may be used as a reinforcing member for the diaphragm middle portion 23 in the speaker 1 in Embodiment 1. A rectangular diaphragm ring 126 which is made of a metal such as brass, and which functions as a washer is bonded and fixed to the rear side of an outer peripheral edge portion of the diaphragm edge portion 124.

The vibration system 120 is configured by bonding and fixing the rear side of the interface between the diaphragm middle portion 123 of the diaphragm 122 and the diaphragm edge portion 124 to an upper end portion of the voice coil bobbin 121a, and hangingly fixing the voice coil 121 to the rear side of the interface between the diaphragm middle portion 123 of the diaphragm 122 and the diaphragm edge portion 124 through the voice coil bobbin 121a.

The vibration system 120 is held by coupling its upper end portion to the frame 160 which is the stationary portion of the speaker 101 by means of the diaphragm edge portion 124. Namely, the outer peripheral edge portion of the diaphragm edge portion 124 is bonded and fixed through the diaphragm ring 126 to the upper step face 168 which is disposed on the inner face of the upper portion of the outer sidewall 162 as the upper support face for the vibration system 120, whereby the diaphragm 122 is disposed there so as to cover the upper opening of the frame 160. The voice coil 121 is inserted and placed in the magnetic gap 114 from the upper side. The diaphragm edge portion 124 plays a role of holding the vibration system 120 to the correct position to realize accurate vibration of the vibration system 120.

The external connection plate 131 is a printed circuit board in which two external connection terminals 130 are integrally disposed in an insulated state. The plate is attached to the recess portion 165 of the frame 160, and one-end sides of the external connection terminals 130 are exposed through the through holes 166 to the both end portions of the inner bottom face of the raised bottom portion 164, respectively. The other end sides of the external connection terminals 130 are exposed to the rear side of the external connection plate 131 in a substantially flush manner, and electrically connected to an external circuit (printed circuit board) of an electronic apparatus such as a portable telephone onto which the other speaker 101 is mounted.

The baffle 140 is formed by applying a pressing process on a metal flat plate, into a celled rectangular tubular shape which is shallower than the frame 160, and fitted to the upper opening of the frame 160 to cover and protect the the diaphragm 122. The lower end of the outer side wall of the baffle 140 presses and fixes from the upper side the outer peripheral edge portion of the diaphragm edge portion 124 and the diaphragm ring 126 against the step face 168. A front sound hole 141 having a substantially same shape as the diaphragm middle portion 123 is disposed in the top plate of the baffle 140. To the outer top face of the baffle 140 and the outer bottom face of the frame 160, damping cloth (not shown) having air permeability is bonded in order to cover the front sound hole 141 and rear sound holes (through holes 167, 167′) which are formed in the faces, adjust the acoustic performance of the other speaker 101, and prevent dust from entering the interior of the other speaker 101.

The other speaker 101 includes: the magnetic circuit 110 having the yoke 111, the magnet 112, and the pole piece 113; the vibration system 120 having the voice coil 121 and diaphragm 122 which are connected to each other through the voice coil bobbin 121a; and the frame 160 which holds the magnetic circuit 110 and the vibration system 120, and the voice coil 121 is placed in the magnetic gap 114, thereby configuring the dynamic other speaker 101.

In the dynamic other speaker 101, when, in a state where the voice coil lead wires 121b are connected to the external connection terminals 130 inside the frame 160, a current is supplied from the external circuit to the voice coil 121 through the external connection terminals 130 and the voice coil lead wires 121b, the voice coil 121 is caused to perform vertical piston motion or vibrate by an interaction between the magnetic fluxes which are directed in a substantially horizontal direction in the magnetic gap 114, and the current flowing through the voice coil 121. The vibration is transmitted to the diaphragm 122 by the voice coil bobbin 121a, and the diaphragm middle portion 123 vibrates while setting the diaphragm edge portion 124 as a fulcrum, thereby generating a sound. Namely, the speaker converts electricity into a sound.

The damper 150 is disposed in the other speaker 101 in order to cooperate with the diaphragm edge portion 124 to play a role of holding the vibration system 120 to a correct position to realize accurate vibration of the vibration system 120. The damper is configured so that the voice coil lead wires 121b are laid on one surface to be guided to the external connection terminals 130.

As shown in FIGS. 6A, 6B, and 6C, the damper body 151 which exerts a damper function, and a part of which functions also as a pair of lead portions for guiding the two voice coil lead wires 121b to the external connection terminals 130 to which the wires are to be connected is disposed in the damper 150. The damper body 151 is placed in one plane. The damper 150 is formed by performing a punching process on one sheet-like member (non-magnetic material) such as a plastic film of polyethylene terephthalate (PET), polyetherimide (PEI), polyimide (PI), or the like, and has a planar structure.

In the damper body 151, an inner ring portion 151a that is a movable portion which is coupled to a lower end portion of the voice coil bobbin 121a opposite to the diaphragm 122, an outer ring portion 151b that is a fixed portion coupled to the frame 160 which is a stationary portion of the other speaker 101, and flexible portions 151c through which the inner ring portion 151a and the outer ring portion 151b are connected to each other are disposed. The damper body is configured so as to support the vibration system 120 with respect to the frame 160.

The inner ring portion 151a is formed into an oval annular member which has a constant width over the whole circumference, so as to cause the outer peripheral end face of the inner ring portion 151a to contact with the inner peripheral face of the voice coil bobbin 121a, or the one surface of the inner ring portion 151a to contact with the lower end face of the voice coil bobbin 121a.

The outer ring portion 151b is formed into a rectangular annular member which has a constant width that is substantially equal to that of the inner ring portion 151a, over the whole circumference, and which is concentric with the inner ring portion 151a, so as to be superimposed on the lower step face 169 which is disposed in the lower inner face of the outer sidewall 162, and which functions as the lower support face for the vibration system 120.

The flexible portions 151c are configured by a plurality (in the illustrated example, eight) of flexurally deformable plate spring-like members which are bent in a crank-like manner in one plane, and which have a constant width that is substantially equal to the widths of the inner ring portion 151a and the outer ring portion 151b over the whole circumference. Intermediate portions of the flexible portions 151c are placed along an oval virtual line which is drawn between the inner ring portion 151a and the outer ring portion 151b and outside the yoke outer sidewall 111a, and which is concentric with the inner ring portion 151a and the yoke outer sidewall 111a. Inward ends of the flexible portions 151c are coupled to the outer peripheral edge of the inner ring portion 151a, and the inward other ends of the flexible portions 151c are coupled to the inner peripheral edge of the outer ring portion 151b. The flexible portions 151c cause the inner ring portion 151a and the outer ring portion 151b to be connected to each other at a plurality (in the illustrated example, eight) of places which are shifted in the circumferential direction of the damper body 151.

The connection pattern between the inner ring portion 151a and the outer ring portion 151b through the flexible portions 151c is formed into a shape in which, since the inner ring portion 151a is placed inside the yoke outer sidewall 111a and the outer ring portion 151b is placed outside the yoke outer sidewall 111a, the flexible portions 151c couples between the inner ring portion 151a and the outer ring portion 151b through the discontinued portions 111b, 111b′ that are disposed in a total of four places, i.e., two places on the longitudinal direction center line of the yoke outer sidewall 111a, and two places on the short-side direction center line.

Furthermore, the connection pattern between the inner ring portion 151a and the outer ring portion 151b through the flexible portions 151c is formed into a shape which does not cause the damper performance to be unbalanced depending on the circumferential position of the damper body 151. Namely, the pattern has a symmetrical shape such as an axisymmetrical shape in which the center line in the longitudinal direction center line (in FIG. 6A, the vertical direction) or short-side direction center line (in FIG. 6A, the lateral direction) of the damper body 151 is set as the symmetrical axis, or a point (rotational) symmetrical shape in which the center of the damper body 151 is set as the symmetry center. In the illustrated example, the pattern has an axisymmetrical shape in which any of the center lines in the longitudinal direction and short-side direction of the damper body 151 can be set as the symmetrical axis, and a 180-degree point symmetrical shape in which the center of the damper body 151 is set as the symmetry center (however, excluding tongue pieces 151d).

Furthermore, the connection pattern between the inner ring portion 151a and the outer ring portion 151b through the flexible portions 151c is formed into a shape in which two specific flexible portions 151c′ of the flexible portions 151c function also as a pair of lead portions for guiding the two voice coil lead wires 121b to the external connection terminals 130 to which the wires are to be connected. Namely, the two voice coil lead wires 121b are drawn out from the two places on the short-side direction center line of the voice coil 121 that are directly above two places on the short-side direction center line of the inner ring portion 151a, and the external connection terminals 130 are exposed through the through holes 166 in the both end portions of the inner bottom face of the raised bottom portion 164 which are directly below both corner portions in the end portion in the longitudinal direction (in FIGS. 6A and 7, the upper end portion) of the outer ring portion 151b. Therefore, the connection pattern between the inner ring portion 151a and the outer ring portion 151b through the flexible portions 151c is formed into a shape in which the two specific flexible portions 151c′ of the flexible portions 151c connect the two places on the short-side direction center line of the inner ring portion 151a to the both corner portions in the end portion in the longitudinal direction of the outer ring portion 151b.

Specifically, the flexible portions 151c are configured by a total of eight portions configured by: two portions which connect one place in the one end side (in FIG. 6A, the upper end side) in the longitudinal direction of the inner ring portion 151a of the two places on the center line in the longitudinal direction of the inner ring portion 151a, to one end side (upper end side) of the two sides in the longitudinal direction of the outer ring portion 151b; two portions which connect one place in the other end side (in FIG. 6A, the lower end side) in the longitudinal direction of the inner ring portion 151a to the other end side (in FIG. 6A, the lower end side) of the two sides in the longitudinal direction of the outer ring portion 151b; two portions which connect one place in the one side (in FIG. 6A, the left side) in the short-side direction of the inner ring portion 151a of the two places of the short-side direction center line of the inner ring portion 151a, to the both end side (in FIG. 6A, upper and lower end sides) of the one side (in FIG. 6A, the left side) in the longitudinal direction of the outer ring portion 151b; and two portions which connect one place in the other side (in FIG. 6A, the right side) in the short-side direction of the inner ring portion 151a to the both end side (in FIG. 6A, upper and lower end sides) of the other side (in FIG. 6A, the right side) in the longitudinal direction of the outer ring portion 151b. The flexible portions 151c connect between the inner ring portion 151a which is placed inside the yoke outer sidewall 111a, and the outer ring portion 151b which is placed outside the yoke outer sidewall 111a, through the discontinued portions 111b, 111b′ that are disposed in a total of four places, i.e., two places on the longitudinal direction center line of the yoke outer sidewall 111a, and two places on the short-side direction center line, so as not to cause the damper performance to be unbalanced depending on the circumferential position of the damper body 151. In the flexible portions 151c, the two specific flexible portions 151c′ function also as a pair of lead portions for guiding the two voice coil lead wires 121b to the external connection terminals 130 to which the wires are to be connected. The two specific flexible portions 151c′ are configured by: one flexible portion which connects one place of one side (in FIG. 6A, the left side) in the short-side direction to the one end side (in FIG. 6A, the upper end side) of one side (in FIG. 6A, the left side) in the longitudinal direction of the outer ring portion 151b, through the discontinued portion 111b′ which is disposed in one place in one side of the short-side direction of the two places on the short-side direction center line of the yoke outer sidewall 111a of the two places of the short-side direction center line of the inner ring portion 151a; and one flexible portion which connects one place of the other side (in FIG. 6A, the right side) in the short-side direction to the one end side (in FIG. 6A, the upper end side) of the other side (in FIG. 6A, the right side) in the longitudinal direction of the outer ring portion 151b, through the discontinued portion 111b′ which is disposed in one place in the other side of the short-side direction of the two places on the short-side direction center line of the yoke outer sidewall 111a.

The pair of tongue pieces 151d which are formed continuously with end portions of the two specific flexible portions 151c′ on the side of the outer ring portion 151b are formed in the both corner portions that are directly above the both end portions of the inner bottom face of the raised bottom portion 164 from which the external connection terminals 130 are exposed through the through holes 166, and that are in one end portion (in FIGS. 6A and 7, the upper end portion) in the longitudinal direction of the outer ring portion 151b of the damper body 151. Through holes 151e for passing the voice coil lead wires 121b therethrough are disposed in the tongue pieces 151d.

Bonding layers 151f (the hatched portions in FIG. 6A) are disposed on one surfaces (upper faces) of the two specific flexible portions 151c′ in order to bond and fix the voice coil lead wires 121b. Each of the bonding layers 151f has a linear shape which is continuous from a basal end portion which is coupled to the inner ring portion 151a to the through hole 151e of the corresponding tongue piece 151d that is formed continuously with the end portion on the side of the external connection terminals 130, or a broken line like shape in which one or more interrupted parts are formed. The bonding layers 151f are formed by, for example, application of an adhesive material.

The damper 150 has as a whole an axisymmetric structure in which the longitudinal-direction center line of the damper body 151 is set as the symmetrical axis.

As shown in FIGS. 7 to 9, in the vibration system 120 in which the upper end portion is connected and held by the diaphragm edge portion 124 to the upper step face 168 that is disposed as the upper support face for the vibration system 120 in the upper inner face of the outer side-wall 162 of the frame 160 that is a stationary portion of the other speaker 101, the lower end is connected and held by the damper 150 to the lower step face 169 that is disposed as the lower support face for the vibration system 120 in the lower inner face of the outer sidewall 162 of the frame 160 that is a stationary portion of the speaker 101. Namely, the damper body 151 is horizontally stretched between the lower end portion of the voice coil bobbin 121a and the lower step face 169 that is disposed as the lower support face for the vibration system 120 in the lower inner face of the outer sidewall 162 of the frame 160, by: bonding and fixing the outer peripheral end face of the inner ring portion 151a to the inner peripheral face of the voice coil bobbin 121a; or bonding and fixing the one surface (upper face) of the inner ring portion 151a to the lower end face of the voice coil bobbin 121a, and superimposing the outer ring portion 151b on the lower step face 169 that is disposed as the lower support face for the vibration system 120 in the lower inner face of the outer sidewall 162 of the frame 160, to be boned and fixed thereto, whereby the damper body 151 is enabled to exert a damper function.

At this time, the flexible portions 151c connect between the inner ring portion 151a which is placed inside the yoke outer sidewall 111a, and the outer ring portion 151b which is placed outside the yoke outer sidewall 111a, through the discontinued portions 111b, 111b′ that are disposed in a total of four places, i.e., the two places on the longitudinal direction center line of the yoke outer sidewall 111a, and the two places on the short-side direction center line, so as not to cause the damper performance to be unbalanced depending on the circumferential position of the damper body 151. In the flexible portions 151c, the two specific flexible portions 151c′ configured by: one flexible portion which connects one place of one side (in FIG. 7, the left side) in the short-side direction of two places on the short-side direction center line of the inner ring portion 151a, to the one end side (in FIG. 7, the upper end side) of one side (in FIG. 7, the left side) in the longitudinal direction of the outer ring portion 151b; and one flexible portion which connects one place of the other side (in FIG. 7, the right side) in the short-side direction to the one end side (in FIG. 7, the upper end side) of the other side (in FIG. 7, the right side) in the longitudinal direction of the outer ring portion 151b guide the two voice coil lead wires 121b to the external connection terminals 130 to which the wires are to be connected.

Namely, the configuration where the two voice coil lead wires 121b which are drawn out from the two places of the lower end portion of the voice coil 121 that are directly above the end portions of the two specific flexible portions 151c′ on the side of the inner ring portion 151a, and on the short-side direction center line of the voice coil 121 are bonded and fixed to the bonding layers 151f disposed on the one surfaces (upper faces) of the two specific flexible portions 151c′ allows the two voice coil lead wires 121b to be bent into a substantially L-like shape along the two specific flexible portions 151c′, and to be guided to the both corner portions in the one end portion (in FIG. 7, the upper end portion) in the longitudinal direction of the outer ring portion 151b that are directly above the both end portions of the raised bottom portion 164 from which the external connection terminals 130 are exposed through the through holes 166, while passing through the discontinued portions 111b which are disposed in two places on the short-side direction center line of the yoke outer sidewall 111a, and between the yoke outer sidewall 111a and the outer sidewall 162 of the frame 160. In this way, the process of laying the two voice coil lead wires 121b by means of forming to the external connection terminals 130 to which the wires are to be connected is realized not in the air of the interior of the other speaker 101, but in a part of the damper body 151, i.e., on the one surfaces of the two specific flexible portions 151c′.

When the voice coil lead wires 121b are bonded and fixed to the bonding layers 151f of the two specific flexible portions 151c′, enough slacks are provided between the end portions of the voice coil lead wires 121b on the drawn out side from the voice coil 121, and the portions where the two specific flexible portions 151c′ are bonded and fixed to the bonding layers 151f, in order to allow and not to impeded the voice coil 121 to vibrate.

After the laying process by means of forming, the two voice coil lead wires 121b are connected by soldering or spot welding 180 to one end sides of the external connection terminals 130 which are exposed in the both end portions of the inner bottom face of the raised bottom portion 164 through the through holes 166 that are disposed in the both end portions of the bottom plate 161a of the raised bottom portion 164, through the through holes 151e of the tongue pieces 151d that are formed continuously with the end portions the two specific flexible portions 151c′ on the side of the outer ring portion 151b.

As described above, the damper 150 is used in the speaker including: the magnetic circuit 110 having the yoke 111, the magnet 112, and the pole piece 113; the vibration system 120 having the voice coil 121 and diaphragm 122 which are connected to each other through the voice coil bobbin 121a; and the frame 160 which holds the magnetic circuit 110, the vibration system 120, and the external connection terminals 130, the voice coil 121 being placed in the magnetic gap 114, and the voice coil lead wires 121b are guided to the external connection terminals 130 while being laid on the one surface. The embodiment has: the inner ring portion 151a which is a movable portion that is coupled to the end portion of the voice coil bobbin 121a opposite to the diaphragm 122; the outer ring portion 151b which is a fixed portion coupled to the frame 160 that is the stationary portion of the speaker 101; and the plurality of flexible portions 151c through which the inner ring portion 151a and the outer ring portion 151b are connected to each other. The damper body 151 which supports the vibration system 120 with respect to the frame 160 is disposed. The flexible portions 151c includes the specific flexible portions 151c′ which function also as a pair of lead portions for guiding the two voice coil lead wires 121b to the external connection terminals 130 to which the wires are to be connected. The process of laying the voice coil lead wires 121b by means of forming is realized not in the air of the interior of to the frame 160 but in a part of the damper body 151, i.e., on the one surfaces of the two specific flexible portions 151c′. Therefore, the process of laying the voice coil lead wires 121b by means of forming can be performed easily and properly, the forming of the voice coil lead wires 121b can be stabilized, and the positional accuracy of the voice coil lead wires 121b with respect to the external connection terminals 130 can be improved, so that improvement of the productivity of the speaker 101 can be realized. The flex resistance of the voice coil lead wires 121b can be improved, and also improvement of the input resistance characteristics of the speaker 101 can be realized. Particularly, the damper body 151 supports the vibration system 120 with respect to the frame 160. Therefore, the magnet 112 of the magnetic circuit 110 can be enlarged to enhance the strength of the magnetic circuit 110, whereby the sensitivity of the speaker 101 can be improved (as compared with the speaker 1 of Embodiment 1).

Furthermore, the lower end of the vibration system 120 which has the maximum distance from the diaphragm edge portion 124 is supported by the damper body 151, and hence a high damper performance can be obtained. Moreover, two points, i.e., the upper and lower ends of the vibration system 120 are supported by the diaphragm edge portion 124 and the damper body 151, and hence the vibration system 120 can produce more stable and accurate vibration. Therefore, the input resistance characteristics of the speaker 101 can be further improved.

Moreover, the damper body 151 is placed in the one plane, and the process of laying the voice coil lead wires 121b by means of forming is realized on the one flat surfaces of the specific flexible portions 151c′. Therefore, the process of laying the voice coil lead wires 121b by means of forming can be performed easily and properly, so that further improvement of the productivity of the speaker 101, further thinning of the speaker 101, and further improvement of the input resistance characteristics of the speaker 101 can be realized.

Furthermore, the damper 150 which has a planar structure formed by performing a punching process on one sheet-like member, and which can realize improvement of the productivity, thinning, and improvement of the input resistance characteristics of the speaker 101 can be economically obtained.

Furthermore, the speaker 101 includes the damper 150 of the embodiment, and hence it is possible to realize a thin speaker which has a high productivity, a high input resistance, a high output, and a high sensitivity.

### DESCRIPTION OF REFERENCE NUMERALS

1, 101 speaker

10, 110 magnetic circuit

11, 111 yoke

12, 112 magnet

13, 113 pole piece

14, 114 magnetic gap

20, 120 vibration system

21, 121 voice coil

21a, 121a voice coil bobbin

21b, 121b voice coil lead wire

22, 122 diaphragm

30, 130 external connection terminal

50, 150 damper

51, 151 damper body

51a outer ring portion (movable portion)

51b inner ring portion (fixed portion)

51c flexible portion

52 lead portion

60, 160 frame

151a inner ring portion (movable portion)

151b outer ring portion (fixed portion)

151c flexible portion

151c′ specific flexible portion (lead portion)

1. A speaker damper for a speaker including:
a magnetic circuit having a yoke, a magnet, and a pole piece;
a vibration system having a voice coil and diaphragm which are connected to each other through a voice coil bobbin; and
a frame which holds said magnetic circuit, said vibration system, and external connection terminals,
said voice coil being placed in a magnetic gap, wherein
voice coil lead wires are guided to said external connection terminals while being laid on one surface.

2. A speaker damper for a speaker including:
a magnetic circuit having a yoke, a magnet, and a pole piece;
a vibration system having a voice coil and diaphragm which are connected to each other through a voice coil bobbin; and
a frame which holds said magnetic circuit, said vibration system, and external connection terminals,
said voice coil being placed in a magnetic gap, wherein
said damper includes:
a damper body; and
lead portions in which voice coil lead wires are guided to said external connection terminals while being laid on one surface, and
said damper body includes:
a movable portion which is coupled to an end portion of said voice coil bobbin opposite to said diaphragm;
a fixed portion which is coupled to a stationary portion of said speaker; and
a flexible portion through which said movable portion and said fixed portion are connected to each other.

3. A speaker damper for a speaker including:
a magnetic circuit having a yoke, a magnet, and a pole piece;
a vibration system having a voice coil and diaphragm which are connected to each other through a voice coil bobbin; and
a frame which holds said magnetic circuit, said vibration system, and external connection terminals,
said voice coil being placed in a magnetic gap, wherein
said damper includes:
a damper body; and
lead portions in which voice coil lead wires are guided to said external connection terminals while being laid on one surface,
said damper body includes:
a movable portion which is coupled to an end portion of said voice coil bobbin opposite to said diaphragm;
a fixed portion which is coupled to a stationary portion of said speaker; and
a flexible portion through which said movable portion and said fixed portion are connected to each other, and
said damper is formed by performing a punching process on one sheet-like member to have a planar structure.

4. A speaker damper for a speaker including:
a magnetic circuit having a yoke, a magnet, and a pole piece;
a vibration system having a voice coil and diaphragm which are connected to each other through a voice coil bobbin; and
a frame which holds said magnetic circuit, said vibration system, and external connection terminals,
said voice coil being placed in a magnetic gap, wherein
said damper includes:
a damper body; and
lead portions in which voice coil lead wires are guided to said external connection terminals while being laid on one surface,
said damper body includes:
a movable portion which is coupled to an end portion of said voice coil bobbin opposite to said diaphragm;
a fixed portion which is coupled to a stationary portion of said speaker; and
a plurality of flexible portions through which said movable portion and said fixed portion are connected to each other, and
said flexible portions include specific flexible portions which function also as said lead portions.

5. A speaker damper for a speaker including:
a magnetic circuit having a yoke, a magnet, and a pole piece;
a vibration system having a voice coil and diaphragm which are connected to each other through a voice coil bobbin; and
a frame which holds said magnetic circuit, said vibration system, and external connection terminals,
said voice coil being placed in a magnetic gap, wherein
said damper includes:
a damper body; and
lead portions in which voice coil lead wires are guided to said external connection terminals while being laid on one surface,
said damper body includes:
a movable portion which is coupled to an end portion of said voice coil bobbin opposite to said diaphragm;
a fixed portion which is coupled to a stationary portion of said speaker; and
a plurality of flexible portions through which said movable portion and said fixed portion are connected to each other,
said flexible portions includes specific flexible portions which function also as said lead portions, and
said damper is formed by performing a punching process on one sheet-like member to have a planar structure.

6. A speaker including a speaker damper according to claim 1.

7. A speaker including a speaker damper according to claim 2.

8. A speaker including a speaker damper according to claim 3.

9. A speaker including a speaker damper according to claim 4.

10. A speaker including a speaker damper according to claim 5.
